(19) United States
(12) Patent Application Publication
(10) Pub. No.: US 2013/0052402 A1
(43) Pub. Date: Feb. 28, 2013

(54) AIR PERMEABLE LAMINATE HAVING FASTENING STRUCTURE

(71) Applicant: Yuen-Lun Tsai, Taipei City (TW)

(72) Inventor: Yuen-Lun Tsai, Taipei City (TW)

(73) Assignees: Eric Shyuu, Taipei City (TW); Kenneth Cheng, Taipei City (TW)

(21) Appl. No.: 13/218,729

(22) Filed: Aug. 26, 2011

(51) Int. Cl. B32B 3/06

(52) U.S. Cl. 428/99

(57) ABSTRACT

An air permeable laminate having a fastening structure is provided, which includes a fiber web layer having a plurality of holes formed therein, wherein a plurality of fibers of the fiber web layer protrudes from the peripheries of the holes by pulling out the fibers contained in the fiber web layer while the holes are formed in the fiber web layer, and the fiber web layer is served as a fastening structure; and a substrate, wherein at least one surface of the substrate is attached to the fiber web layer.

### BACKGROUND OF THE INVENTION

1. Field of the Invention

The present invention relates to an air permeable laminate having a fastening structure, which is served as a loop element of a hook-and-loop fastener.

2. The Prior Arts

In the disposable product market, the needs for better-fitting and more comfortable disposable hygiene products, such as disposable diapers, and infant learning pants, have increased. As such, a laminate having high elastic recovery rate, and high air permeability can satisfy these needs. Generally, the elastic laminate is also expected to be elastically stretchable in dual directions. Disposable personal care products and health care products usually have enough air permeability and strength to be used for general purposes. The air permeability refers to the rate of passage of air or water vapor through fabric. The strength is relative to the tensile strength. In theory, the extensibility properties of the polymer films of the laminate can be individually enhanced, but for carrying out the theoretical property, a material having better extensibility has to be used, the material cost is therefore increased. Consequently, there is always a need for fabricating personal care products or health care products using the elastic laminates having good air permeability and strength.

When the air permeable laminate is used for manufacturing an intimate product or personal hygiene product, a fastening structure has to be installed for allowing the user to fasten the intimate product or personal hygiene product on his/her body, for example the hook-and-loop fastener (such as Velcro® brand hook-and-loop fastener) is often installed on a baby diaper, so that the diaper can be easily fastened to an infant's body by the users. The sanitary napkins for females or the general gauze masks can also have the fastening structure. Because the conventional hook-and-loop fastener includes a hook element and a loop felt, the intimate product or personal hygiene product can be easily fastened to or released from the human body.

Furthermore, because the hook-and-loop fastener includes a hook element and a loop felt, the production cost of a finished product depends on the cost of the hook element and the loop felt.

### SUMMARY OF THE PRESENT INVENTION

The objective of the present invention is to provide an air permeable laminate having a fastening structure. When the air permeable laminate which has the fuzzy surfaces is manufactured into a product, only a hook element is needed to be installed on the product for forming a hook-and-loop fastener without a loop felt, so that the production cost can be reduced.

In the present invention, a laminate including a fiber web layer is processed in order to form a plurality of holes in the fiber web layer so that the laminate becomes air permeable, and meanwhile the fibers contained in the fiber web layer are pulled out and protrude from the peripheries of the holes when the holes are formed. Therefore, the air permeable laminate of the present invention instead of the conventional loop felt can be used in the hook-and-loop fastener.

To achieve the above objective, the present invention provides an air permeable laminate having a fastening structure, comprising: a fiber web layer having a plurality of holes formed therein, a plurality of fibers of the fiber web layer protruding from peripheries of the holes, wherein the fiber web layer is served as the fastening structure; and a substrate, at least one surface of the substrate being attached to the fiber web layer, wherein the fibers protruding from peripheries of the holes are formed by pulling out the fibers contained in the fiber web layer while the holes are formed in the fiber web layer. The air permeable laminate of the present invention instead of the conventional loop felt can be used in the hook-and-loop fastener.

In the present invention, the substrate can be an elastic or inelastic fabric.

In the present invention, the fiber web layer can be a monolayer of non-woven fabric, or a non-woven fabric combined with another fabric made of different material.

In the present invention, the non-woven fabric used in the air permeable laminate can be an elastic non-woven fabric or an inelastic non-woven fabric.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a cross-sectional view showing an air permeable laminate according to the first embodiment of the present invention;

FIG. 2 is a cross-sectional view showing the air permeable laminate having a fastening structure according to the second embodiment of the present invention;

FIG. 3 is a cross-sectional view showing that a plurality of fibers of the fiber web layer protrudes from the peripheries of the holes according to one embodiment of the present invention; and

FIG. 4 is a cross-sectional view showing that the air permeable laminate having a fastening structure and being served as a loop element is engaged with the hook element according to one embodiment of the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

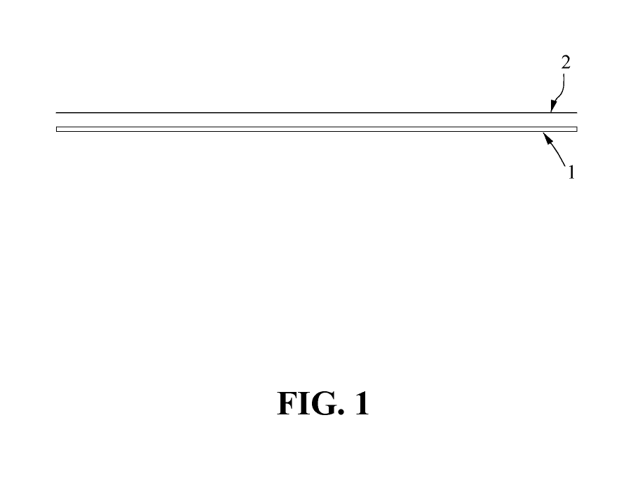

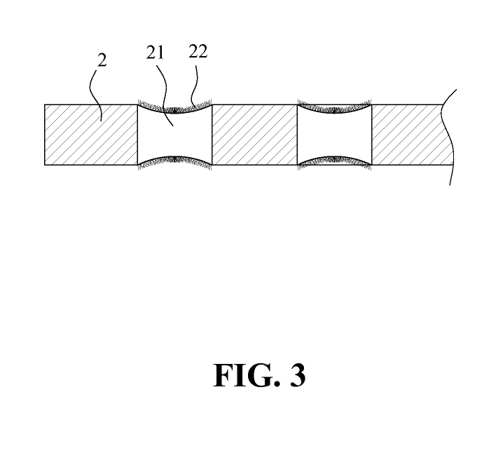

FIG. 1 is a cross-sectional view showing an air permeable laminate according to the first embodiment of the present invention. The air permeable laminate includes a substrate 1, and a fiber web layer 2. The substrate 1 can be made of any kind of fabric, and the fabric can have or not have elasticity. The fiber web layer 2 can be a monolayer of elastic or inelastic non-woven fabric. A plurality of holes 21 are formed in the fiber web layer 2 by using a suitable machine (such as a punching machine, or an ultrasonic forming machine), and by using the cutting tool of the machine used for forming the holes, the fibers 22 contained in the fiber web layer 2 are pulled out to form the fuzzy surfaces which are caused by the fibers 22 protruding from the peripheries of the holes 21 while the holes 21 are formed (as shown in FIG. 3). The holes 21 can have any geometric shape, such as round, triangular, or rectangular shape as needed. After the holes 21 with the fibers 22 protruding from the peripheries thereof are formed in the fiber web layer 2, the fiber web layer 2 is attached to one or two surfaces of a substrate 1 by using a high-frequency device or a thermal melting device. Finally, an air permeable laminate with fuzzy surfaces is obtained, wherein the fiber web layer 2 of the air permeable laminate is served as a fastening structure. The fiber web layer 2 with fuzzy surfaces which are caused by the fibers 22 protruding from the peripheries of the holes 21 in the fiber web layer 2 are used as the conventional loop felt of the hook-and-loop fastener.

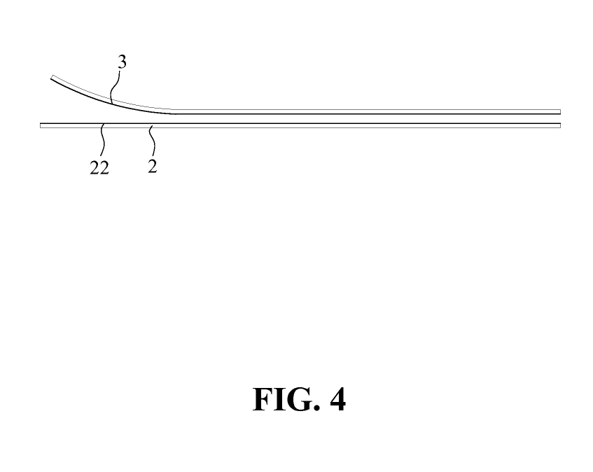

As shown in FIG. 4, when the air permeable laminate with fuzzy surfaces, which is served as a conventional loop felt of a hook-and-loop fastener, is manufactured into a product, only a hook element 3 is needed to be installed on the product for forming a hook-and-loop fastener without a loop felt. Accordingly, the hook element 3 can be engaged with the fibers 22 which protrude from the peripheries of the holes in the fiber web layer 2 of the air permeable laminate so that the objects can be fastened.

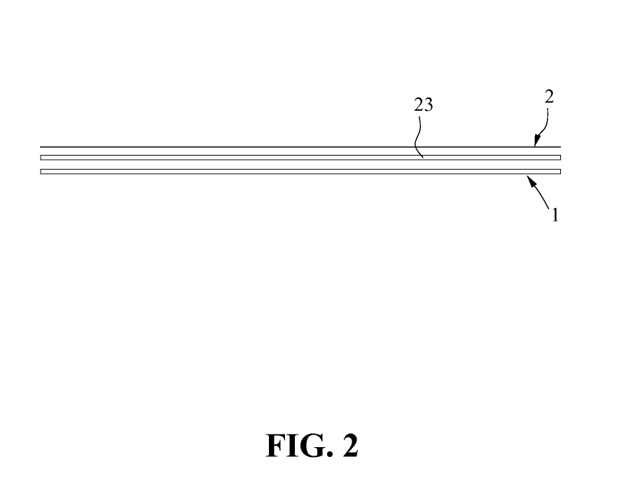

FIG. 2 is a cross-sectional view showing the air permeable laminate having a fastening structure according to the second embodiment of the present invention. The air permeable laminate includes a substrate 1, and a fiber web layer 2. The substrate 1 can be made of any kind of fabric, and the fabric can have or not have elasticity. The fiber web layer 2 can be an elastic or inelastic non-woven fabric. The fiber web layer 2 is combined with a fabric 23 to form a double-layer structure. A plurality of holes 21 are formed in the fiber web layer 2 by using a suitable machine (such as a punching machine, or an ultrasonic forming machine), and by using the cutting tool of the machine used for forming the holes, the fibers 22 contained in the fiber web layer 2 are pulled out to form the fuzzy surfaces which are caused by the fibers 22 protruding from the peripheries of the holes 21 while the holes 21 are formed (as shown in FIG. 3). After the holes 21 with the fibers 22 protruding from the peripheries thereof are formed in the fiber web layer 2, the fabric 23 combined with the fiber web layer 2 is attached to one or two surfaces of a substrate 1 by using a high-frequency device or a thermal melting device. Finally, an air permeable laminate with fuzzy surfaces is obtained, wherein the fiber web layer 2 of the air permeable laminate is served as a fastening structure. The fiber web layer 2 with fuzzy surfaces which are caused by the fibers 22 protruding from the peripheries of the holes 21 in the fiber web layer 2 are used as the conventional loop felt of the hook-and-loop fastener.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An air permeable laminate having a fastening structure, comprising:
a fiber web layer having a plurality of holes formed therein, a plurality of fibers of the fiber web layer protruding from peripheries of the holes, wherein the fiber web layer is served as the fastening structure; and
a substrate, at least one surface of the substrate being attached to the fiber web layer.

2. The air permeable laminate according to claim 1, wherein the substrate is a fabric.

3. The air permeable laminate according to claim 1, wherein the fiber web layer is a monolayer of non-woven fabric.

4. The air permeable laminate according to claim 3, wherein the monolayer of non-woven fabric is combined with another fabric made of different material.

5. The air permeable laminate according to claim 1, wherein the fibers protruding from peripheries of the holes are formed by pulling out the fibers contained in the fiber web layer while the holes are formed in the fiber web layer.

6. The air permeable laminate according to claim 3, wherein the non-woven fabric is an elastic non-woven fabric.

7. The air permeable laminate according to claim 4, wherein the non-woven fabric is an elastic non-woven fabric.

8. The air permeable laminate according to claim 3, wherein the non-woven fabric is an inelastic non-woven fabric.

9. The air permeable laminate according to claim 4, wherein the non-woven fabric is an inelastic non-woven fabric.
